(19) United States
(12) Patent Application Publication
(10) Pub. No.: US 2016/0264281 A1
(43) Pub. Date: Sep. 15, 2016

(54) LABEL FEEDING MACHINE

(71) Applicant: MICRO CO., LTD., Tokyo (JP)

(72) Inventor: Kazuo WATANABE, Koriyama-shi, Fukushima (JP)

(21) Appl. No.: 14/785,519

(22) PCT Filed: Dec. 2, 2014
(86) PCT No.: PCT/JP2014/081860

§ 371 Date: Oct. 19, 2015

(30) Foreign Application Priority Data
Dec. 5, 2013 (JP) 2013-252204

(51) Int. Cl. B65C 9/18

(52) U.S. Cl. CPC B65C 9/18

(57) ABSTRACT

Provided is a label feeding device that is capable of efficiently peeling and feeding liner-less labels one by one, said liner-less labels comprising multiple labels that are arranged, without using release paper, such that each label is bonded to the surface of a label thereunder at an overlapping section while being displaced from the lower label at a displaced section.

The labels are moved by means of a conveyor (8) that has on a surface thereof protrusions or grooves to which the labels are temporarily attached, and the conveyor bends at a peeling part (9), thereby peeling off the displaced section (5) of the upper label from the conveyer.

A slider (13) that presses the lower label against the conveyor surface is movably disposed at the peeling part, thereby preventing the lower label from being peeled off from the conveyor.

The displaced section projecting from the conveyor is pinched by a claw mechanism (12) and carried to a label ejection slot (11).

### FIELD OF THE INVENTION

The present invention relates to a label feeding machine capable of feeding labels one by one, and more particularly, to a label feeding machine capable of peeling and feeding liner-less labels having a plurality of labels stuck with the stacking positions shifted without using a release paper, one by one.

### BACKGROUND INFORMATION

As labels, there have been known liner-less labels (non-liner labels) not stuck on a release paper (backing paper) unlike conventional ones. In the liner-less labels (hereinafter sometimes simply referred to as a label), the surface of the label is used as a peeling face, an adhesive face formed on the back thereof is stuck on the surface of a label located thereunder while being shifted with a predetermined width, a plurality of labels are continuously formed into a tape-like shape and wound to form a roll or adhered into a sheet-like shape while being shifted with a predetermined distance. Since such labels do not use a release paper, there are advantages such that no waste is generated, the entire size can be made small to realize space saving, packing costs, transportation costs and the like can be reduced. Such a label peeling machine capable of peeling the continuously stuck labels one by one has been proposed (for example, see Patent Document 1). In the structure of the machine described in Patent Document 1, labels are moved forward or backward by a carrier belt made of a rubber belt, and when the upper label of overlapped labels moves backward, a peeling claw is brought into abutment with the edge portion of the label and peels the label from the labels located thereunder, and the peeled label is held between holding rollers and then taken out by hand.

From the state of the labels stuck as above, it is assumed that each label is classified into an overlapped part that is stuck on and overlapped with the lower label and a shifted part that extends forward and is apart from the lower label. And, the machine described in Patent Document 1 is used for a method wherein a peeling claw is inserted between the lower face of the edge of the overlapped part of the upper label and the upper face of the lower label and forcibly peels the upper label. Accordingly, the structure thereof is complicated, and adhesives tend to accumulate at the peeling claw and the like, and therefore if such portions are not constantly cleaned, a situation where labels cannot be peeled may be caused.

Further, with the machine described in Patent Document 1, when the label moves backward, if the peeling claw fails to securely enter between the overlapped labels and the upper label comes below the peeling claw, peeling of labels cannot be made.

### PRIOR ART DOCUMENTS

### Patent Document

Patent Document 1: JP-A-2012-91910 (Scope of claims, paragraphs 0038 to 0045, and FIG. 5 to FIG. 9)

### SUMMARY OF THE INVENTION

### Problems that the Invention is to Solve

It is an object of the present invention to provide a label feeding machine capable of feeding linerless labels having a plurality of labels overlapped and shifted with a distance and wound to form a roll, one by one, wherein the structure is simple, adhesives of the labels less likely accumulate on several portions of the machine, and the labels can be fed one by one reliably whereby subsequent sticking operation of labels by handwork can efficiently be made.

### Means of Solving the Problems

As mentioned above, in the conventional machines, peeling of label is carried out from the edge portion side of the overlapped part of the label. However, the label feeding machine of the present invention is constructed to pinch a shifted part extending from the lower label by a predetermined width and peel the label, not peeling the label from the edge portion side of the overlapped part of the label. Namely, the present invention provides a label feeding machine which comprises a conveyer which moves circularly, carries liner-less labels, and bends at a peeling portion to cause a shifted part side of the label to project; a claw mechanism which pinches the shifted part of the label projecting from the peeling portion to peel the label and transfers the peeled label to a label ejection slot; and a slider which presses the liner-less labels against the surface of the conveyer when the claw mechanism moves while pinching the shifted part of the peeled label, wherein the surface of the conveyer is formed in a rough face to which the liner-less labels temporarily stick, and at the time of peeling the labels, the slider is movable along the conveyer and urged in the direction toward the peeling portion. The above problems can be solved by the present invention.

Further, the present invention provides a label feeding machine wherein the rough face formed on the surface of the conveyer has projections or grooves, the claw mechanism has a plurality of claw units provided around a rotatable hub, each of the claw units has a fixed claw and a movable claw, the movable claw can move toward and away from the fixed claw so that the movable claw is capable of holding or releasing the shifted part of the label together with the fixed claw by means of a cam follower, and the fixed claw is urged in such a direction of clamping the shifted part.

### Effects of the Invention

The present invention is constructed as above, namely, the label feeding machine comprises a conveyer which moves circularly, carries liner-less labels and bends at a peeling portion to cause a shifted part side of the label to project; a claw mechanism which pinches the shifted part of the label projecting from the peeling portion to peel the label and transports the peeled label to a label ejection slot; and a slider which presses the liner-less labels against the surface of the conveyer when the claw mechanism moves while pinching the shifted part of the peeled label, wherein the surface of the conveyer is formed in a rough face to which the liner-less labels temporarily stick, and at the time of peeling the labels, the slider is movable along the conveyer and urged in the direction toward the peeling portion. The labels are temporarily stuck on the rough face of the conveyer and transferred to the peeling portion, and the shifted part of the upper label can easily be detached from the conveyer since the conveyer bends, and projects forward from the conveyer. And, the shifted part is clamped by the claw mechanism which is placed in a standby condition in close vicinity to the peeling portion, and the label is peeled from the lower label by the movement of the claw mechanism. At this time, since the lower and subsequent labels are pressed against the conveyer surface by the slider and the slider is urged in the direction toward the peeling portion of the conveyer, when the label is peeled, the slider moves against the urging action while pressing the labels to the conveyer face and the lower side labels are not raised. Accordingly, the labels can be peeled one by one reliably. Then, the slider returns to the original position of the peeling portion and is placed in a standby condition.

Further, when projections or grooves are formed for temporary adhesion of the adhesive face of labels as the rough face formed on the surface of the conveyer, the shifted part of the labels temporarily stuck on the conveyer can be easily peeled from the conveyer face and projects in free state when the conveyer bends at the peeling portion and moves. Accordingly, adhesion or accumulation of adhesives can be reduced since the claw mechanism can easily clamp the shifted part, unlike the conventional mechanism where a peeling claw is inserted below the label to which an adhesive is provided. When the claw mechanism has a plurality of claw units provided around a rotatable hub, each of the claw units has a fixed claw and a movable claw each having a holding part, and the movable claw can move toward and away from the fixed claw so that the movable claw is capable of holding or releasing the shifted part of the label together with the fixed claw by means of a cam and a cam follower, it is easy to clamp the shifted part between the holding parts. Further, when the fixed claw is urged in such a direction to clamp the shifted part, it is possible to more reliably hold the shifted part of the labels, and a holding and feeding mechanism can easily be constructed. In addition, when the conveyer is circulated in the upward-and-downward direction and a label-transferring shaft at the peeling portion at which the conveyer bends is provided at the lowest part, the slider moving upward and downward along the conveyer can be urged in the direction toward the peeling portion by gravity (dead load) and therefore the construction can be made further simple.

### BRIEF DESCRIPTION OF THE DRAWINGS

FIG. 1 is a perspective view showing an example of the present invention.

FIG. 2 is an explanatory view showing the structure of the present invention.

FIG. 3 is an explanatory view showing a case where liner-less labels wound in a roll-like shape are set on a roll holder and an enlarged view of a part of the liner-less labels.

FIG. 4 is an explanatory view showing a state where liner-less labels are set on a roll holder.

FIG. 5 shows a label pressing mechanism, and FIG. 5A is an explanatory view showing a state where a pressing mechanism is drawn, and FIG. 5B is an explanatory view showing a state where labels are pressed against a conveyer by the pressing mechanism.

FIG. 6 is an explanatory view showing a state where the labels are peeled from the conveyer.

FIG. 7 is a perspective view showing an example of a slider mechanism.

FIG. 8 is an explanatory view showing a peeling portion of a conveyer.

FIG. 9 is an explanatory view showing a case where a conveyer is reversed.

FIG. 10 is an explanatory view showing a fixed position at which a shifted part of labels is projected.

FIG. 11 is an explanatory view showing a state where a claw unit of a claw mechanism is placed in a standby condition.

FIG. 12 is an explanatory view showing a state where a claw unit of a claw mechanism starts to rotate.

FIG. 13 shows operation conditions and provides explanatory views i.e. FIG. 13A is a state placed in a standby condition, FIG. 13B a state where peeling of labels is just started, and FIG. 13C a state where the label is transferred to a label ejection slot.

### DETAILED DESCRIPTION OF THE PREFERRED EMBODIMENTS

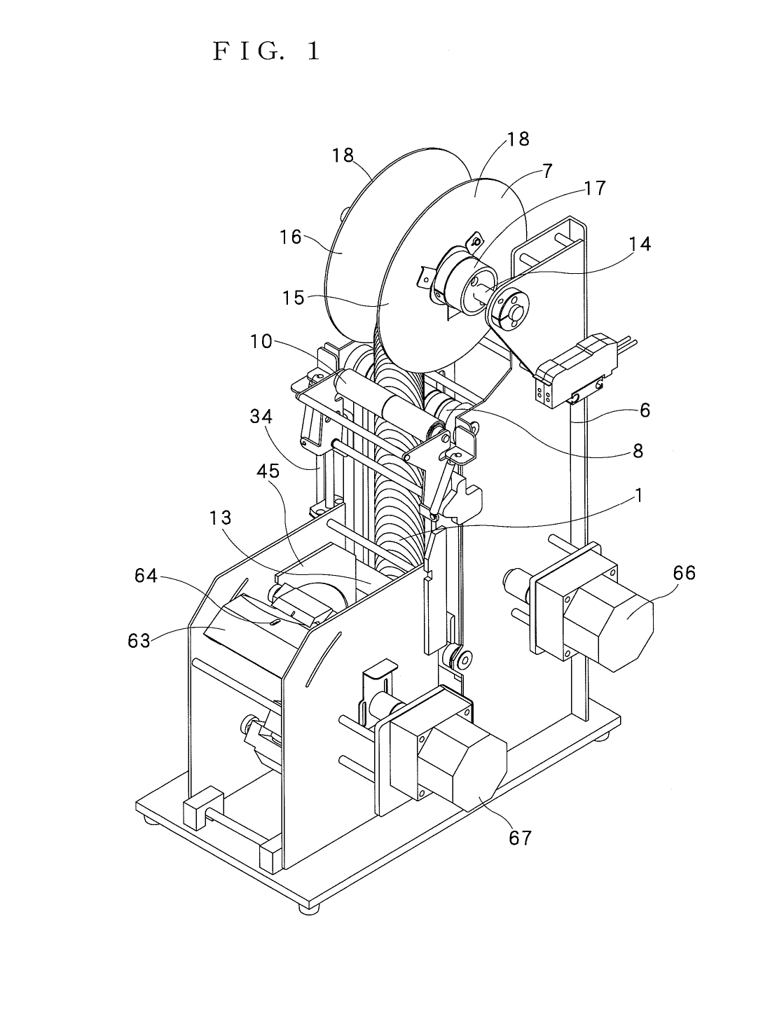

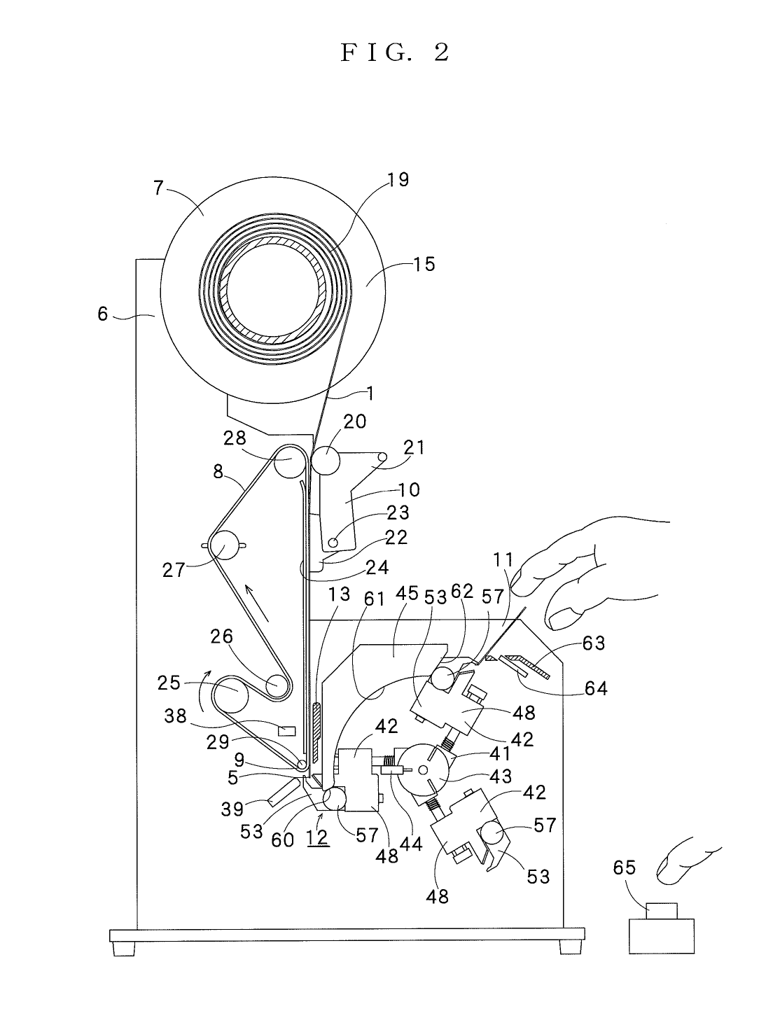

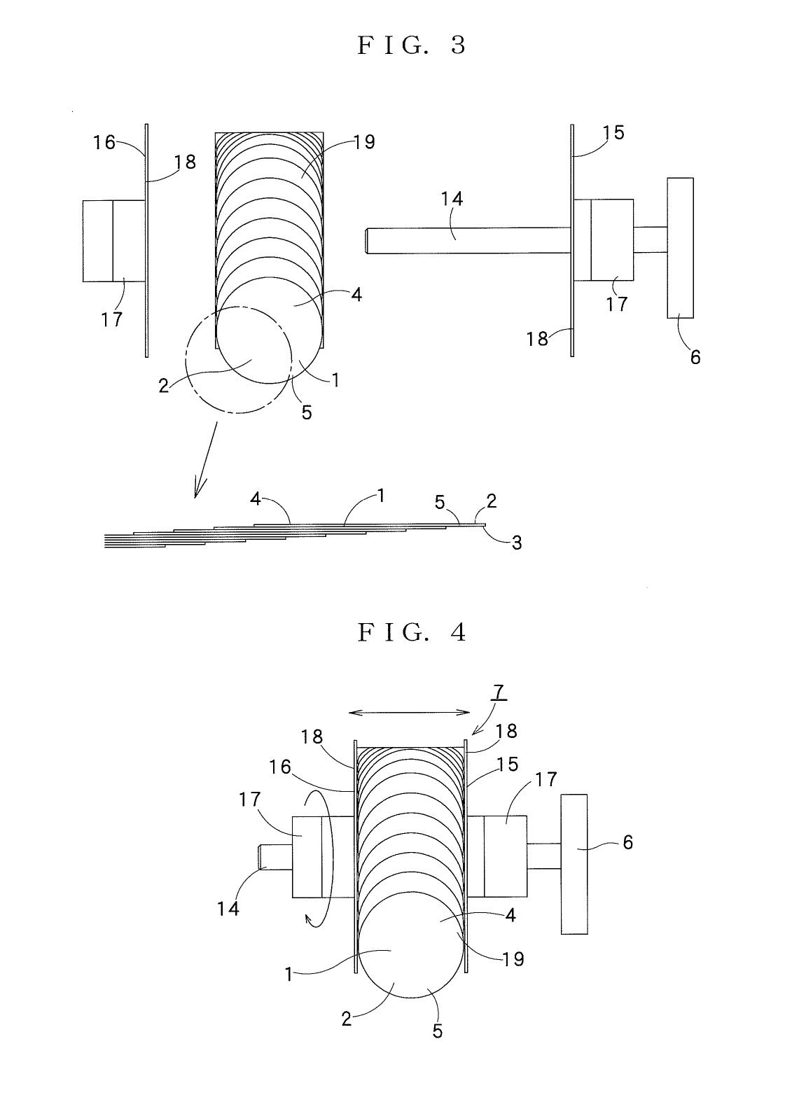

FIG. 1 and FIG. 2 show an example of the present invention. FIG. 1 is a perspective view and FIG. 2 is an explanatory view of the structure. In a label 1 as the subject of the present invention, as illustrated in FIG. 3 with a partially enlarged view, a peeling face is formed on a surface 2 of the label, an adhesive face is provided on a back 3, and the label is stuck on the surface of a lower side label while being shifted with a predetermined width so that these labels are partially overlapped. Most of the upper label is overlappingly stuck on the lower label, and the shifted part extends forward from the lower label. Namely, an overlapping-stuck part 4 of the upper label 1 is stuck on the lower label, but a sifted part 5 is not stuck on the lower side label located just under the upper label and is stuck on the surface of a label placed thereunder when the labels are wound in a roll-like shape.

The label feeding machine of the present invention is mainly provided with a machine main body 6, a holder part 7 which holds a label wound in a roll-like shape, a conveyer 8 which circulates and bends at a peeling portion 9 so that labels are transferred in a tape-like shape and a shifted part is projected, a label pressing mechanism 10 which presses the labels against the conveyer, a claw mechanism 12 which pinches the shifted part 5 of the label projecting from the peeling portion to peel the label and transfers the peeled label to a label ejection slot 11, and a slider 13 which presses the lower and subsequent labels against the conveyer face when the claw mechanism moves while pinching the shifted part 5.

The holder portion 7 has inner side and outer side roll holders 15, 16 which are attached to a roll holder rotation axis 14 provided on the machine main body 6. The roll holders 15, 16 have an installing part 17 and a side face plate 18. The outer side roll holder 16 is detached and labels wound in a roll-like shape 19 are inserted into the roll holder rotation axis 14, and then the outer side roll holder 16 is attached to the roll holder rotation axis 14, and the labels wound in a roll-like shape 19 are clamped and held between the inner side roll holder 15 and the outer side roll holder 16. The installing part 17 of the holders is provided at such a position being adjustable in the right-and-left direction, and when the labels are drawn out by the conveyer 8, the installing part 17 rotates to feed the labels smoothly.

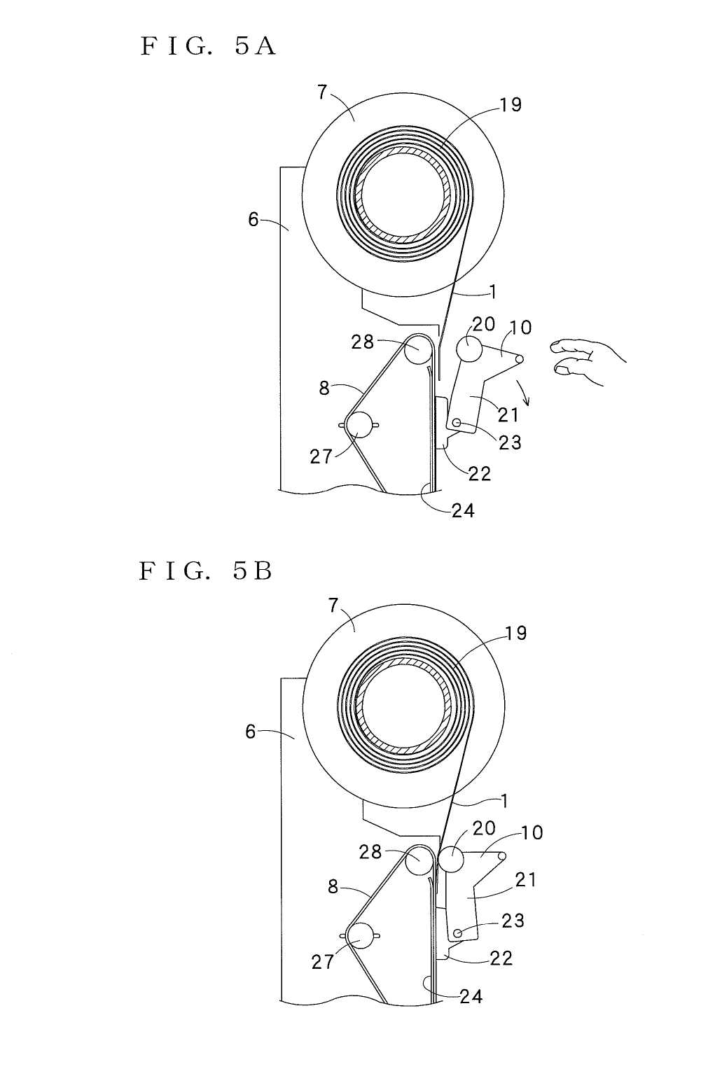

The label pressing mechanism 10 has a movable part 21 having a pressing part 20 at its front end, which is movably attached via a pivot 23 to a support portion 22 provided on the machine main body 6 so as to tilt. The pressing part 20 is configured by a roller in the example shown in the figures, but may be configured by a sheet-like plate. And, when a movable part 21 is slanted as shown in FIG. 5A, a space will be formed with the conveyer 8, and the label 1 can be guided along the conveyer face and set easily. Afterward, when the movable part 21 is raised, the pressing part 20 presses the label 1 against the conveyer face as shown in FIG. 5B so as to keep the label not apart from the conveyer 8. The movable part 21 may be urged by a spring (not shown) in the direction toward the conveyer, or the movable part may slant in the direction toward the conveyer so that the pressing part 20 presses the label 1 by its dead load.

In the examples shown in the figures, the conveyer 8 is driven by a conveyer motor 66, moved downward along a conveyer slide plate 24 extending in an upward-and-downward direction, cyclically circulated and raised by a drive pulley 25, an outside passive pulley 26, a tension pulley 27 and an inside passive pulley 28, and bended at the part of a label-delivering shaft 29 provided at the lower position. The part of the label-delivering shaft 29 is the peeling portion 9 at which the shifted part 5 of the label 1 departs from the conveyer 8. The surface of the conveyer 8 is formed in a rough face so that the adhesive face on the back 3 of the label can temporarily stick thereon. The rough face is roughened at such a level that the label will not be closely stuck and will be temporarily stuck on the conveyer 8 and carried together, preferably formed by risings such as dot-like or granular like risings, small projections, rib-like projections 30, grooves 31, or the like. The conveyer 8 may be configured by one or plural belts made of a plastic material, a rubber material, a metal wire net material, etc. having an appropriate hardness in response to adhesives of the label. Further, the pitch P between the projections 30 or grooves 31 can adequately be changed in response to the size of the label or adhesion.

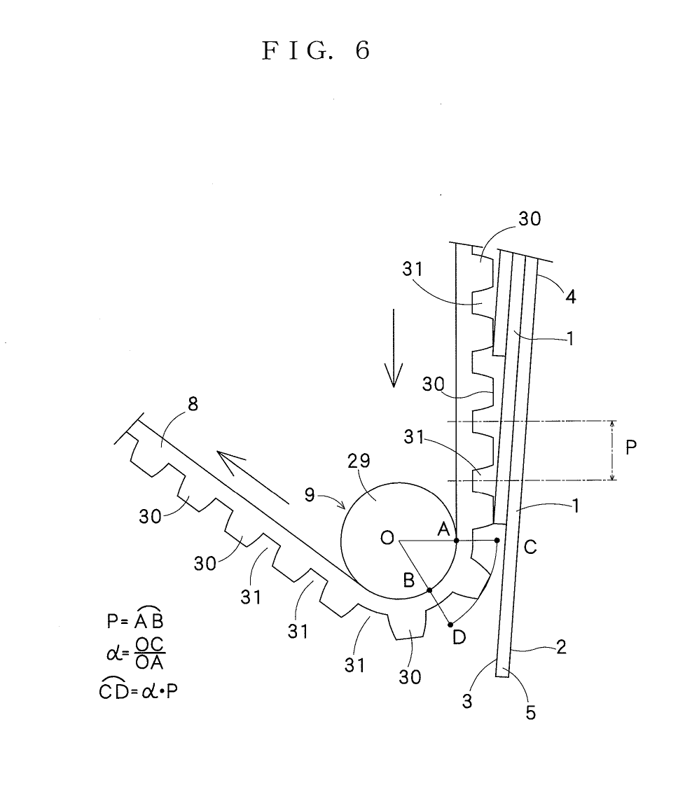

The peeling state of the label when the rib-like projections 30 or grooves 31 are provided on the conveyer 8 will be explained below with reference to FIG. 6. On an assumption, the labels put together by adhesion are temporarily stuck on the projections 30 formed together with the grooves 31 of a pitch (P) and carried along a slide plate at the straight part. When the labels reach a peeling portion 9, the conveyer bends at the part of a label-delivering shaft 29 and moves continuously. In FIG. 6, when the arc length AB of the conveyer face having the center (O) of the label-delivering shaft 29 at its center which is in contact with the label-delivering shaft 29 becomes equal to the pitch P, i.e. AB=P, if the ratio of the radius OC to the label including the thickness of the conveyer to the radius OA of the shaft is referred to as α (alpha), although the label transfers with the pitch P at the straight part, its transfer route increases α times of the pitch P at the arc CD. Since the label generally has no elasticity and the projections of the conveyer has an appropriate hardness, the label cannot adsorb the increased transfer route and, as the results, the sifted part 5 of the label peels from the conveyer between C and D of the arc.

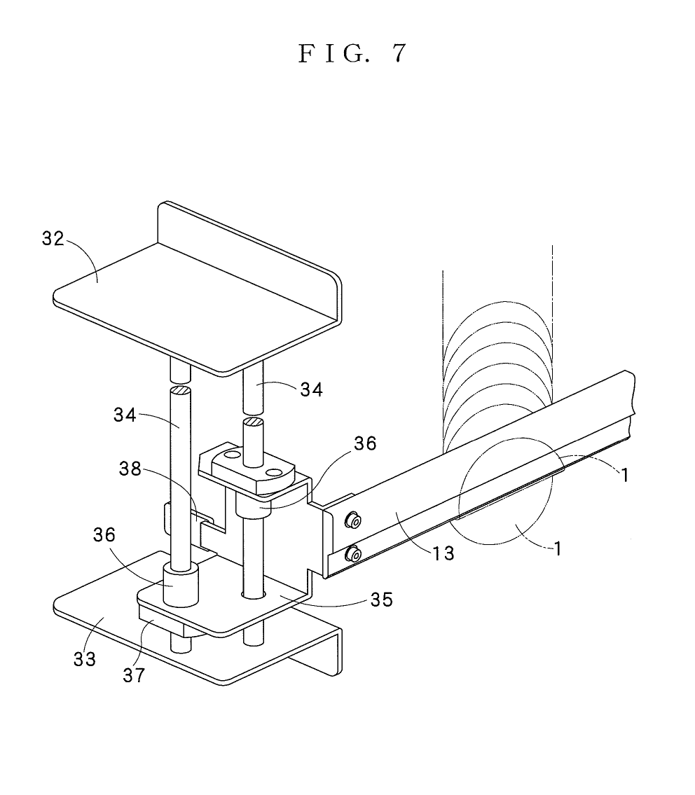

At the peeling portion 9 of the conveyer 8, as mentioned above, a slider 13 which presses the label 1 against the conveyer is provided movably in an upward-and-downward direction in the examples along the conveyer 8. FIG. 7 shows an example of the slider mechanism, brackets 32, 33 are provided at upper and lower portions of the machine main body 6 and two guide shafts 34 are provided therebetween, a slider-supporting frame 35 is attached to the guide shafts via an appropriate bearing or guide tube 36 slidably upward and downward, and one end of the slider 13 is fixed to the slider-supporting frame 35 so that the slider 13 can move stably without departing from the outside of the label 1. The downward movement of the slider-supporting frame 35 can be stopped by a stopper 37, and on one side of the slider-supporting frame 35, a slider' s original position-detecting sensor 38 is provided to detect the position of the slider 13 when the slider 13 stops at the lower original position. In the examples shown in the figures, the slider 13 has a slanting face or an arcuate face at its lower end edge so that it can be raised upward smoothly by the label when the upper label is peeled from the lower labels. Further, the slider is made of a material having an adequate weight so that it downs to the original position by its dead load when the upper label is released from the lower labels, but the slider may be provided with an adequate spring to urge it toward the original position. Here, instead of the supporting mechanism by the guide shaft 34, an appropriately shaped supporting frame may be provided to hold both sides of the slider 13 so that the slider moves along the supporting frame (not shown).

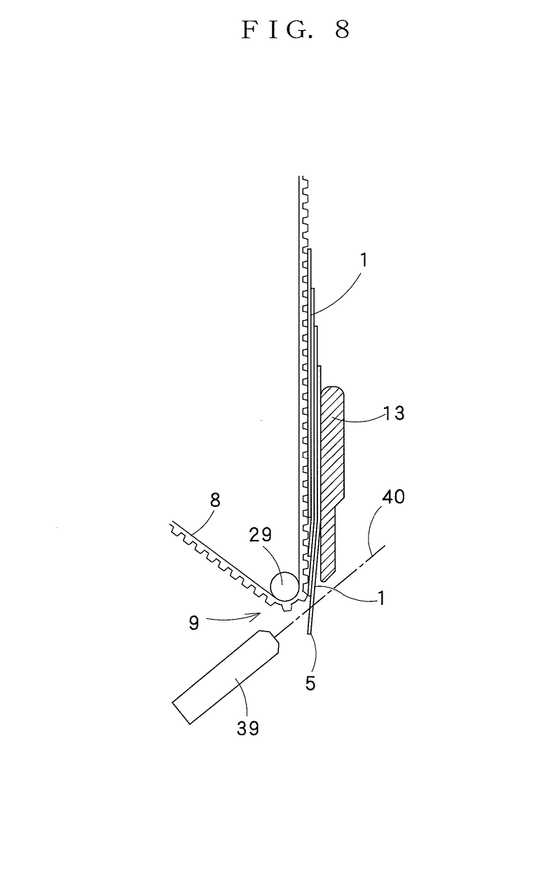

At the peeling part 9, a label-detecting sensor 39 to detect the label 1 is provided (see FIG. 8). An optical axis 40 of the label-detecting sensor 39 is adjusted to cross the shifted part 5 of the label 1 extending from the peeling part 9. Since the shifted part 5 is a part to be clamped by the claw mechanism 12, a short period of time from detection of the shifted part by the sensor 39 to the stop of the conveyer can be adjusted so as to secure an allowance for pinching in such a length sufficient for holding.

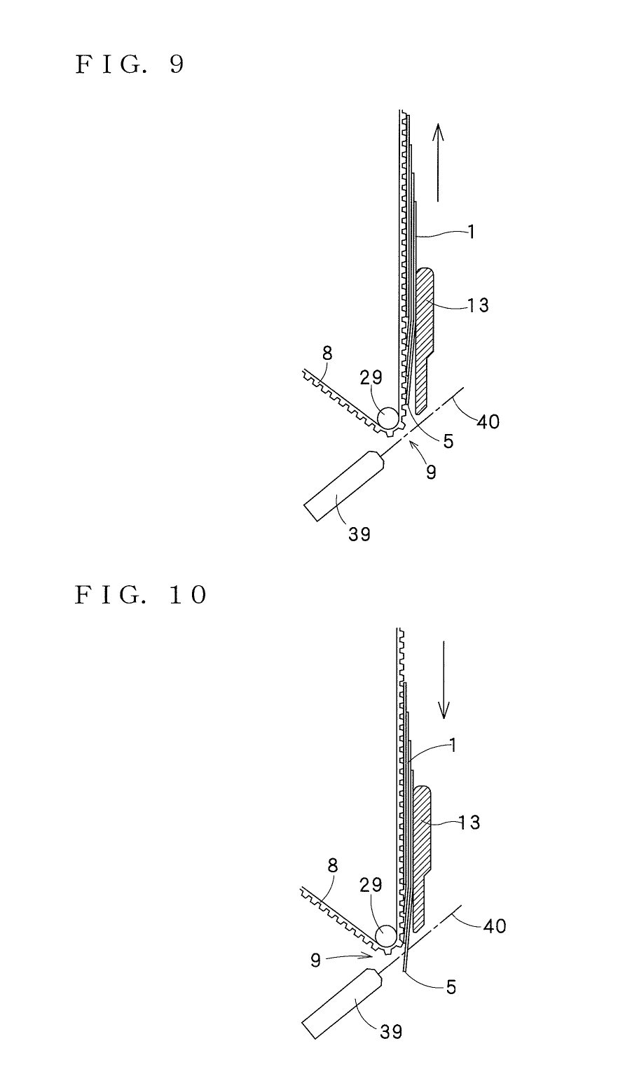

If the claw mechanism 12 fails to clamp the shifted part 5 of the label 1, the label-detecting sensor 39 determines that it is a failure, and as shown in FIG. 9, the conveyer 8 is reversed a little. And then, the conveyer is forwarded to a normal direction until the label moves to the pinching position and, as shown in FIG. 10, the label 1 is set again. If the claw mechanism fails to clamp the label after continuous several trials, the entire machine main body is configured to stop automatically.

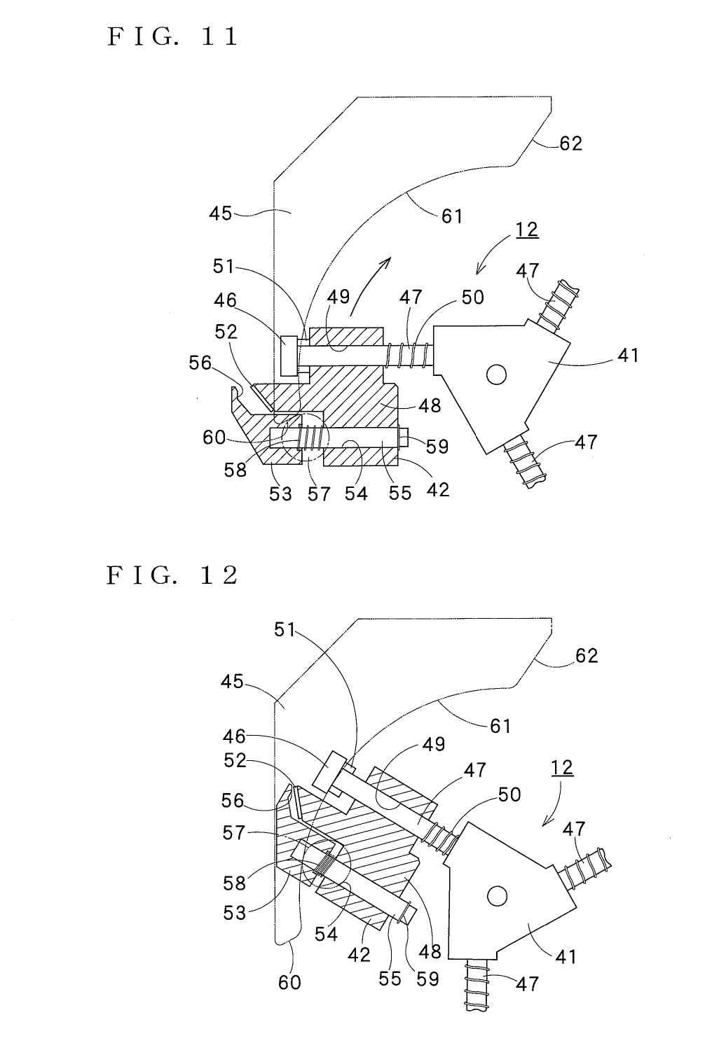

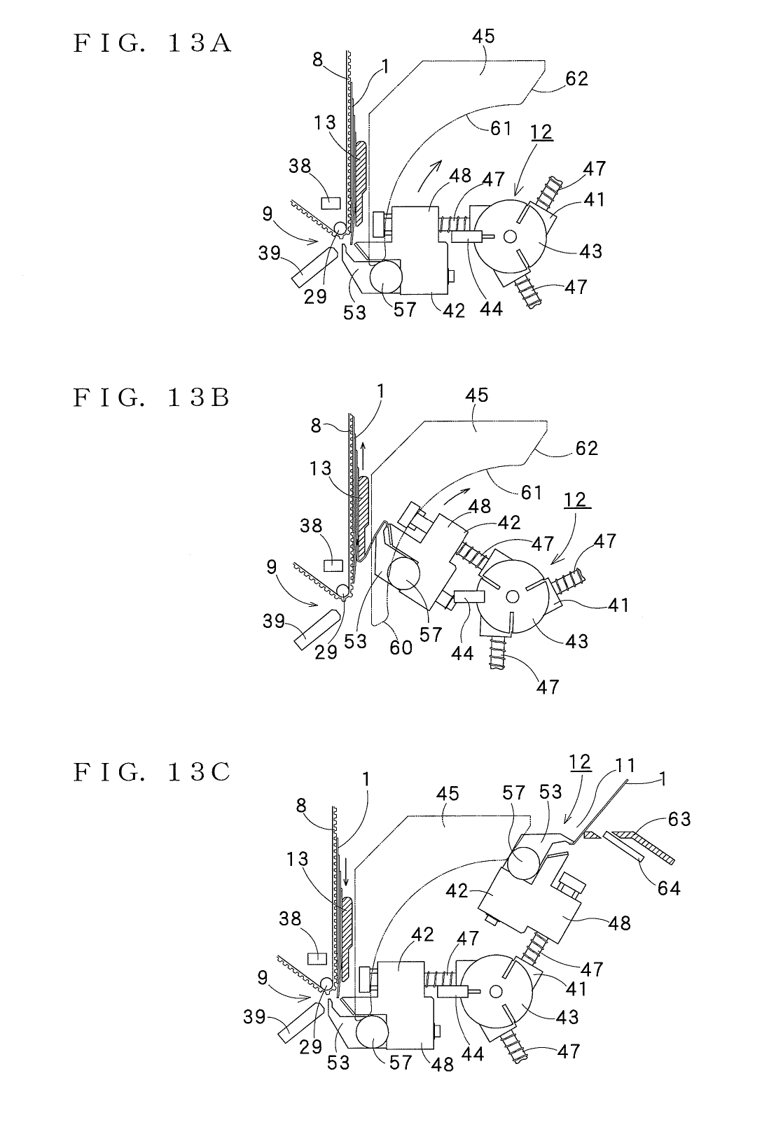

Referring to FIG. 11 and FIG. 12, the claw mechanism 12 has a rotatable hub 41 to be rotated by a hub rotation motor 67 and plural, three in the examples of these figures, claw units 42 provided around the hub 41. Outside the hub 41, as shown in FIG. 13, a position-detecting dog 43 is provided, and a hub' s position-detecting sensor 44 located in the vicinity of the dog 43 is used to control the rotation position of the hub 41. In the claw unit 42, a supporting shaft 47 having a roller 46 rotationally moving along the side face of a cam plate 45 at its front end is fixed to the hub 41, the supporting shaft 47 is slidably inserted into an installing hole 49 of the fixed claw 48, and the fixed claw 48 is urged outwardly by a pressing spring 50 to the position at which the fixed claw 48 abuts on a stopper 51. At the front end of the fixed claw 48, a clamping part 52 is formed, and into an installing hole 54 provided at the side of the fixed claw, a supporting shaft 55 of a movable claw 53 is slidably inserted. The movable claw 53 has a clamping part 56 at its front end, and fixed to the front end of the supporting shaft 55, and in the figure, it has a cam follower 57 on the back face side. On the supporting shaft 55 between the fixed claw 48 and the movable claw 53, is provided a return spring 58 which urges the movable claw 53 in such a direction that the clamping part 56 of the movable claw 53 departs from the clamping part 52 of the fixed claw 48. By the action of the return spring 58, the movable claw 53 moves outwardly to such a position at which a stopper 59 provided on the supporting shaft 55 abuts on the fixed claw 48.

The cam plate 45 is provided with a standby slant face 60 which is slanting to allow the movable claw 53 to move outwardly so that the cam follower 57 is placed in contact with the standby slant face 60 and in a standby condition in such a state that a space is formed between the clamping parts 52, 56, in the state wherein the claw unit 42 of the claw mechanism 12 is in the vicinity of the peeling part 9 as shown in FIG. 11; an arcuate face 61 which allows the movable claw 53 to move inwardly so that the cam follower 57 is placed in contact with the arcuate face 61 and the shifted part 5 of the label 1 will be clamped between the clamping parts 52, 56, when the claw unit 42 rotates as shown in FIG. 12; and a release slant face 62 which allows the movable claw 53 to move so that the cam follower 57 rolls out, the movable claw 53 moves outwardly, and the label 1 is released, when the claw unit 42 rotates up to the label ejection slot 11.

At the label ejection slot 11, a label receiver 63 is provided, and a label ejection-detecting sensor 64 is provided to confirm the ejection of the label, in such a position corresponding to a detection hole formed on the receiver 63. And, a switch 65 is provided to control the entire movement of the machine main body 6. When the label 1 on the label receiver 63 is taken out from the label ejection slot 11, the label ejection-detecting sensor 64 turns on, the claw mechanism 12 being in a standby condition automatically peels only one piece of the label 1 and moves to the label receiver 63, the label 1 is left in a standby condition until it is taken out, and this operation is repeated.

Referring to FIG. 13, as shown in FIG. 13A, the label 1 is always placed in a standby condition at the start position. At this time, the slider 13 is located at such a position that a slider' s original position-detecting sensor 38 can detect the slider 13 (a slider' s original position).

When the switch 65 is pressed, the conveyer 8 starts the operation by a conveyer motor 66, and the label 1 is transferred to such a position at which the label-detecting sensor 39 detects the label (pinching position of label). When the switch is pressed further, the hub 41 of the claw mechanism 12 is turned by a hub rotation motor 67. By the rotation of the claw unit 42 of the claw mechanism, the cam follower 57 provided on the movable claw 53 goes up onto the arcuate face 61 of the cam plate 45, and then as shown in FIG. 13B, the claw clamps the label 1 and the front end of the label is peeled off. At this time, since the slider 13 is brought into such a state that it is wrapped by the peeled label, the slider 13 moves upward by the transfer of the label. Since the lower labels are pressed against the conveyer face by the slider 13, it is possible to prevent the labels lower than the peeled label from peeling from the conveyer 8, and only one label can be reliably peeled from the overlapping-stuck labels.

When the clamped label is completely peeled from the second label, the slider 13 moves downward by its dead load, and the slider returns to the original position and placed in a standby condition in such a state that the slider presses the labels against the conveyer face as shown in FIG. 13C

When the label 1 is transferred to the label receiver 63 of the label ejection slot 11 by the rotation of the hub 41, the rotation of the hub 41 is stopped by the hub position-detecting sensor 44 at this position, and the claw unit 42 is placed in a standby condition while holding the label. When the label 1 is taken out from the receiver 63, the label ejection-detecting sensor 64 turns on, the claw unit 12 being placed in a standby condition peels the next and only one label automatically from the conveyer 8 and moves to the label receiver 63 as described above, and placed in a standby condition until the label 1 is taken out. As described above, the action of the label ejection-detecting sensor 64 functions like the switch 65 is pressed. Such operation is repeated and the labels can be taken out one by one subsequently.

In the above examples, the conveyer is located below the holder part and the conveyer is moved in upward-and-downward direction, but as the case requires, the conveyer may be located in a substantially horizontal direction and moved horizontally. In this instance, the slider may be urged in a direction toward the peeling portion by an appropriate spring.

### EXPLANATION OF SYMBOLS

1 Label
4 Overlapping-stuck part
5 Shifted part
6 Machine main body
7 Holder part
8 Conveyer
9 Peeling portion
10 Label pressing mechanism
11 Label ejection slot
12 Claw mechanism
13 Slider
29 Label-delivering shaft
38 Slider's original position-detecting sensor
39 Label-detecting sensor
41 Hub
42 Claw unit
44 Hub's position-detecting sensor
45 Cam plate
48 Fixed claw
53 Movable claw
57 Cam follower
63 Label receiver
64 Label ejection-detecting sensor
65 Switch
66 Conveyer motor
67 Hub rotation motor

1. A label feeding machine which comprises a conveyer which moves circularly, carries liner-less labels and bends at a peeling portion to cause a shifted part side of the label to project; a claw mechanism which pinches the shifted part of the label projecting from the peeling portion to peel the label and transfers the peeled label to a label ejection slot; and a slider which presses the liner-less labels against the surface of the conveyer when the claw mechanism moves while pinching the shifted part of the peeled label, wherein the surface of the conveyer is formed in a rough face to which the liner-less labels temporarily stick, and at the time of peeling the labels, the slider is movable along the conveyer and urged in the direction toward the peeling portion.

2. The label feeding machine according to claim 1, wherein the rough face formed on the surface of the conveyer has projections or grooves.

3. The label feeding machine according to claim 1, wherein the conveyer is circularly moved in the upward-and-downward direction, the peeling portion is located at a lower position, a label-transferring shaft is provided at the peeling portion, the conveyer bends at the label-transferring shaft, the slider is urged in the direction toward the peeling portion by dead load.

4. The label feeding machine according to claim 1, wherein the slider is fixed to a slider-supporting frame and the slider-supporting frame moves along a guide shaft provided on the machine main body.

5. The label feeding machine according to claim 1, wherein a label-pressing mechanism which presses the labels against the conveyer is provided on a side face of the conveyer.

6. The label feeding machine according to claim 1, wherein the claw mechanism has a plurality of claw units provided around a rotatable hub, each of claw units has a fixed claw and a movable claw, and the movable claw can move toward and away from the fixed claw so that the movable claw is capable of holding or releasing the shifted part of the label together with the fixed claw by pressing by means of a cam follower.

7. The label feeding machine according to claim 6, wherein the movable claw is urged in such a direction that the clamping part of the movable claw departs from the clamping part of the fixed claw, and when the cam follower comes into contact with the cam, the clamping part of the movable claw is moved in such a direction that the clamping part of the movable claw is pressed against the clamping part of the fixed claw, and when the clamping part of the fixed claw is urged in such a direction that the shifted part is clamped when the clamping part of the fixed claw is pressed.
